(19) United States
(12) Patent Application Publication
(10) Pub. No.: US 2012/0212057 A1
(43) Pub. Date: Aug. 23, 2012

(54) PORTABLE DEVICE AND IMAGE RECORDING DEVICE

(76) Inventor: Takafumi OKUMA, Kanagawa (JP)

(21) Appl. No.: 13/369,453

(22) Filed: Feb. 9, 2012

(30) Foreign Application Priority Data
Feb. 17, 2011 (JP) NO. 2011-032550

(51) Int. Cl. H02J 7/04

(52) U.S. Cl. 307/48; 320/148

(57) ABSTRACT

A portable device operated by a rechargeable battery includes a connecting unit that connects the portable device and a power supply that supplies a driving current and a charging current; a detection unit that detects a battery voltage of the rechargeable battery; and a charging control unit that controls starting and stopping of charging of the rechargeable battery. When the battery voltage is greater than a predetermined threshold value, the charging control unit causes the power supply to stop supplying the charging current until the battery voltage becomes less than the predetermined threshold value. When the battery voltage is less than the predetermined threshold value, the charging control unit causes the power supply to start supplying the charging current until the rechargeable battery is fully charged.

### BACKGROUND OF THE INVENTION

1. Field of the Invention

An embodiment of the present invention relates to a portable device operated by a rechargeable battery and an image recording device operated by a rechargeable battery.

2. Description of the Related Art

Recently, small portable devices that are driven by rechargeable batteries, which are used as power supplies, have been frequently used. As a method of recharging the rechargeable battery, a method has been commonly adopted such that a charging circuit is provided inside the portable device and the recharging is performed internally in the portable device. As a method of supplying electric power for recharging, it has been known to use a Universal Serial Bus (USB) port or an Alternating Current (AC) adapter for supplying electric power for recharging a battery inside a computer. For example, Patent Document 1 (Japanese Published Unexamined Application No. 2009-247142) discloses that a rechargeable battery is recharged by controlling an electric current or an electric voltage supplied from a USB host.

Further, Patent Document 2 (Japanese Published Unexamined Application No. 2003-046853) discloses that, in a camera to which electric power is supplied through a communication cable, a connecter for connecting the cable includes a switch, so that electric power is supplied from both the communication cable and a battery. Further, Patent Document 3 (Japanese Published Unexamined Application No. 2002-218300) discloses that, when a camera is connected to a cradle, electric power is supplied from the cradle and an operation mode of the camera is switched to a communication mode.

In a conventional portable device, sometimes a rechargeable battery is recharged while the portable device is operated. In such a case, recharging and discharging are simultaneously performed. Thus there is a problem that the capacity deterioration of the rechargeable battery is accelerated.

Especially, when the portable device is a camera or the like, it is possible that an operating current becomes greater than a charging current instantaneously, due to a charging operation for an electric flash or an operation of a motor. When an operating current is greater than a charging current, the rechargeable battery discharges during that moment. Consequently, the rechargeable battery repeats charging and discharging for short time intervals. Therefore, the capacity deterioration of the rechargeable battery can be greatly accelerated.

Based on the problem, in a camera, a photographing operation is performed exclusively with respect to charging of a rechargeable battery and an operation during charging of the rechargeable battery tends to be avoided. Therefore, conventionally, for a camera, such as for a preview in a store, a dedicated AC adapter or a charged rechargeable battery for the preview is usually used. However, when a rechargeable battery for a preview in a store is used, the management of the remaining capacity of the rechargeable battery may require some work. Therefore, there is a problem that the rechargeable battery is inconvenient.

The embodiment of the present invention has been developed in view of the above problems and in order to resolve the above problems. An objective of the embodiment is to provide a portable device and an image recording device that operate stably and that can suppress deterioration of rechargeable batteries.

### SUMMARY OF THE INVENTION

In one aspect, there is provided a portable device operated by a rechargeable battery, the portable device including a connecting unit that connects the portable device and a power supply that supplies a driving current for driving the portable device and a charging current for charging the rechargeable battery; a detection unit that detects a battery voltage of the rechargeable battery; and a charging control unit that controls starting and stopping of charging of the rechargeable battery. When the battery voltage is greater than or equal to a predetermined threshold value, the charging control unit causes the power supply to stop supplying the charging current to the rechargeable battery until the battery voltage becomes less than the predetermined threshold value. When the battery voltage is less than the predetermined threshold value, the charging control unit causes the power supply to start supplying the charging current to the rechargeable battery until the rechargeable battery is fully charged.

In another aspect, there is provided an image recording device operated by a rechargeable battery, the image recording device including a connecting unit that connects the image recording device and a power supply that supplies a driving current for driving the image recording device and a charging current for charging the rechargeable battery; a detection unit that detects a battery voltage of the rechargeable battery; and a charging control unit that controls starting and stopping of charging of the rechargeable battery. When the battery voltage is greater than or equal to a predetermined threshold value, the charging control unit causes the power supply to stop supplying the charging current to the rechargeable battery until the battery voltage becomes less than the predetermined threshold value. When the battery voltage is less than the predetermined threshold value, the charging control unit causes the power supply to start supplying the charging current to the rechargeable battery until the rechargeable battery is fully charged.

Other objects, features and advantages of the present invention will become more apparent from the following detailed description when read in conjunction with the accompanying drawings.

### BRIEF DESCRIPTION OF THE DRAWINGS

FIG. 1 is a diagram illustrating an image recording device according to an embodiment;

FIG. 2 is a diagram illustrating functional configuration of a processor of the image recording device;

FIG. 3 is a flowchart illustrating charging control in the image recording device;

FIG. 4 is a diagram illustrating charging and discharging operations in the image recording device;

FIG. 5 is a flowchart illustrating an example of the charging control in the image recording device;

FIG. 6 is a flowchart illustrating an example of restriction of an operation by a processor; and

FIG. 7 is a flowchart illustrating an example of controlling driving current by the processor.

### DETAILED DESCRIPTION OF THE PREFERRED EMBODIMENTS

In an embodiment, a threshold value for determining whether charging of a rechargeable battery is to be started or not is defined. Recharging of the rechargeable battery is performed only when the battery voltage of the rechargeable battery is less than the threshold value.

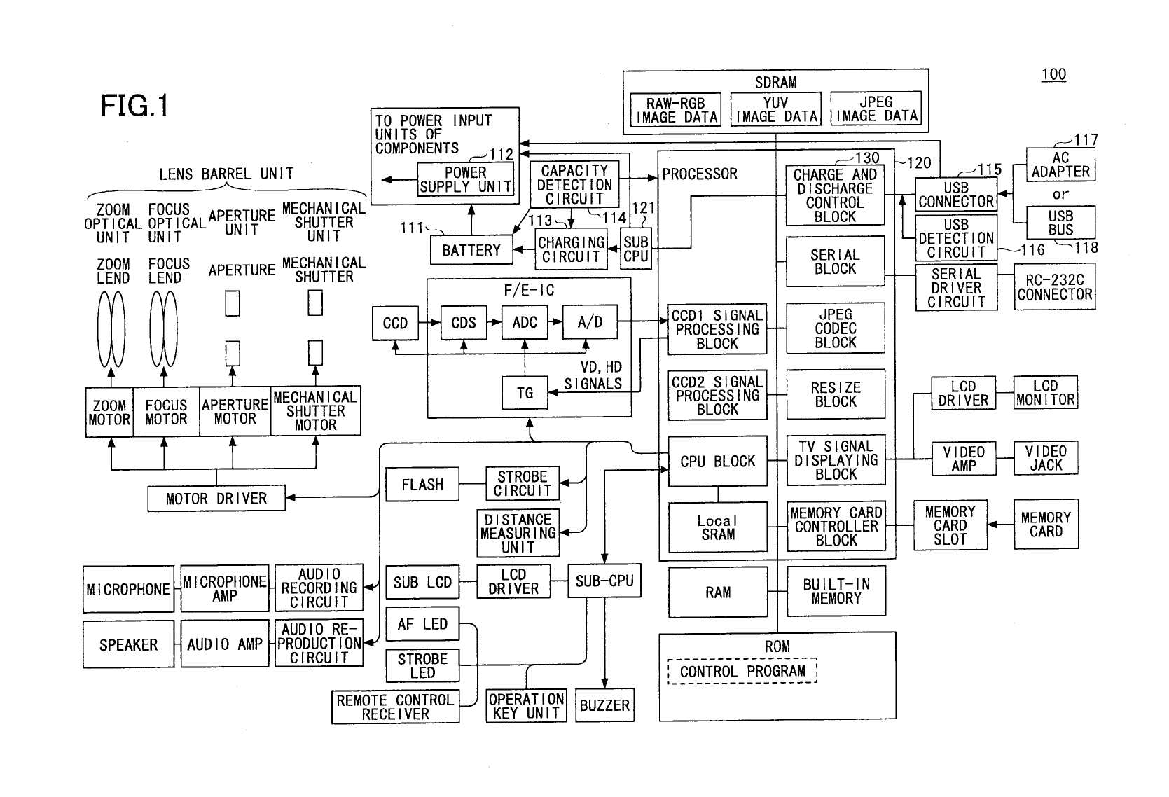

Hereinafter, the embodiment of the present invention is explained by referring to figures. The embodiment is explained by assuming that the portable device that is driven by the rechargeable battery is an image recording device, such as a digital camera. FIG. 1 is a diagram illustrating an image recording device according to the embodiment.

Hereinafter, in the explanation of FIG. 1, only a configuration of the image recording device with respect to charging control of the rechargeable battery is explained. The remaining configurations of the image recording device shown in FIG. 1 are the same as those of a conventional image recording device.

The image recording device 100 includes a battery 111, a power supply unit 112, a charging circuit 113, a capacity detection circuit 114, a USB connector 115, a USB detection circuit 116, a processor 120 and a sub central processing unit (CPU) 121.

The battery 111 is a rechargeable battery that can be charged and that can discharge electricity. The battery 111 drives the image recording device 100. The power supply unit 112 generates voltages that may be required by units of the image recording device 100 from the battery 111. The charging circuit 113 charges the battery 111. The capacity detection circuit 114 detects the remaining capacity of the rechargeable battery 111. The capacity detection circuit 114 of the embodiment detects the battery voltage of the rechargeable battery 111 as the remaining capacity of the rechargeable battery 111.

The USB connector 115 connects the image recording device 100 to an AC adapter 117 or to a USB BUS 118 of a personal computer. Here, the image recording device 100 is for supplying a charging current supplied to the charging circuit 113 and a driving current for driving the image recording device 100. Further, the USB connector 115 of the embodiment performs a communication function for communicating with an external device, in addition to the connecting function for connecting the recording device to the electric power supplies.

The USB detection circuit 116 detects a state of a data line between the USB connector 115 and the processor 120.

The processor 120 is responsible for overall control of the operation of the image recording device 100. Further the processor 120 communicates with the sub CPU 121, and the processor 120 controls charging of the battery 111 through the sub CPU 121. The details of the functions of the processor 120 are explained later. The sub CPU 121 controls the charging circuit 113 based on directions from the processor 120. Further, the sub CPU 121 controls the power supply unit 112.

Generally, a USB includes a VBUS line terminal having a power-supply voltage of 5 V; a GND line which is used as a reference; and a D+ terminal and a D− terminal which are data lines. In the embodiment, when the VBUS terminal is connected to the USB connector 115, the USB detection circuit 116 detects whether the AC adapter 117 is connected to the USB connector 115 or the USB BUS 118 is connected to the USB connector 115. Then, based on the detection result, an upper limit of a charging current that can be supplied to the charging circuit 113 is defined, and the charging current is supplied to the charging circuit 113.

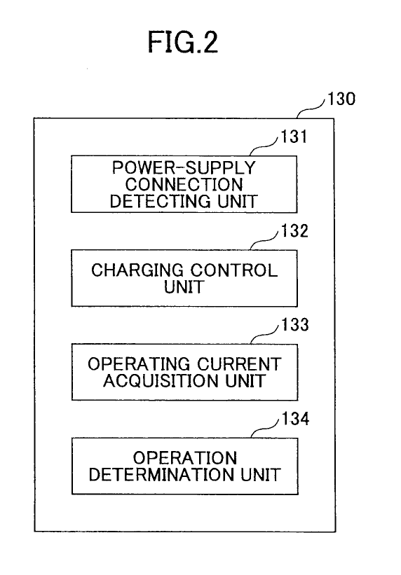

Hereinafter, the functions of the processor 120 of the embodiment are explained by referring to FIG. 2. FIG. 2 is a diagram illustrating a functional configuration of the processor 120 of the image recording device 100. The processor 120 of the embodiment includes a charge and discharge control block 130. In regard to a control of the battery 111, the charge and discharge control block 130 controls charging and discharging of the battery 111, and the charge and discharge control block 130 passes control signals to the sub CPU 121. The sub CPU 121 controls the charging and the discharging of the battery 111 by controlling the charging circuit 113 in accordance with the control signals. Hereinafter, with respect to FIG. 2, the functional configuration of the charge and discharge control block 130 included in the processor 120 is explained.

The charge and discharge control block 130 of the embodiment includes a power-supply connection detecting unit 131, a charging control unit 132, an operating current acquisition unit 133, and an operation determination unit 134.

The power-supply connection detecting unit 131 determines whether one of the AC adapter 117 or the USB BUS 118 is connected to the USB connector 115, based on a detection result by the USB detection circuit 116. The charging control unit 132 is responsible for controls of the charging and discharging of the battery 111. For example, when the battery voltage of the battery 111 becomes less than or equal to the threshold value, the charging control unit 132 outputs a control signal for starting charging the battery to the sub CPU 121.

The operating current acquisition unit 133 acquires an operating current of the image recording device 100. In the image recording device 100 of the embodiment, an operating current detection unit (not shown) that detects the operating current of the image recording device 100 is provided. The operating current acquisition unit 133 of the embodiment acquires a detection result of the operating current detection unit. The operation determination unit 134 determines an operating state of the image recording device 100. Specifically, the operation determination unit 134 determines, for example, whether the image recording device 100 is turned on, or whether an operator is currently operating the image recording device 100.

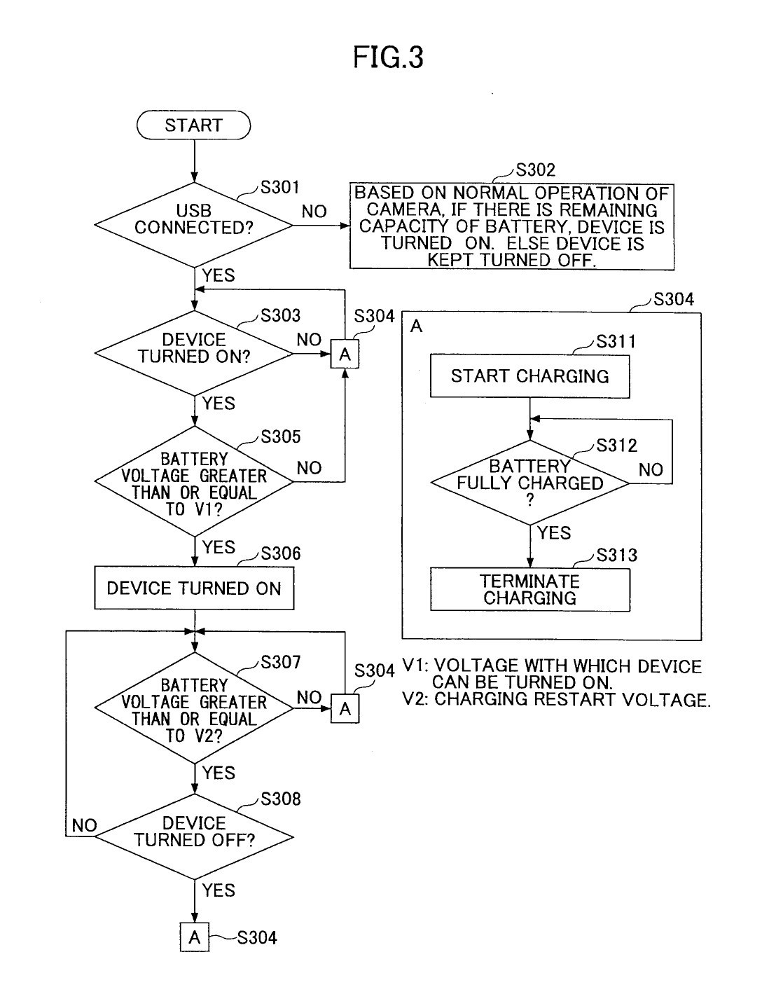

Next, charging control in the image recording device 100 according to the embodiment is explained by referring to FIG. 3. FIG. 3 is a flowchart illustrating the charging control in the image recording device 100.

In the image recording device 100 of the embodiment, the power-supply connection detection unit 131 determines whether a power supply for supplying a charging current is connected to the USB connector 115, based on the detection result of the USB detection circuit 116 (step S301). When the power-supply connection detection unit 131 determines that the power supply is not connected to the USB connector 115, the processor 120 detects a battery voltage of the battery 111 using the capacity detection circuit 114. When the battery voltage is greater than or equal to a charging restart voltage V2, the processor 120 turns on the image recording device 100. Further, when the battery voltage is less than the charging restart voltage V2, the processor 120 turns off the image recording device 100 (step S302). Here, a normal operation is an operation of the recording device 100 other than an operation, such as a charging operation for an electric flash or an operation of a motor, for which an operating current greater than the average operating current of the image recording device 100 is to be consumed. Details of the charging restart voltage V2 are described later.

When the power-supply connection detection unit 131 determines, at step S301, that the power supply is connected to the USE connector 115, the operation determination unit 134 determines whether the image recording device 100 is turned on or (step S303). When the operation determination unit 134 determines, at step S303, that the image recording device 100 is not turned on, the process proceeds to a process A (step S304). The charging control unit 132 handles the process A.

When the operation determination unit 134 determines, at step S303, that the image recording device 100 is turned on, the charging control unit 132 determines whether the battery voltage of the battery 111 detected by the capacity detection circuit 114 is greater than or equal to a near-end voltage V1 (step S305). When the charging control unit 132 determines that the battery voltage of the battery 111 is less than the near-end voltage V1, the process proceeds to step S304 and the charging control unit 132 executes the process A. When the charging control unit 132 determines that the battery voltage of the battery 111 is greater than or equal to the near-end voltage V1, the processor 120 turns on the image recording device 100 (step S306).

Here, the near-end voltage V1 is a threshold voltage for determining whether the image recording device 100 can be turned on or not. The value of the near-end voltage V1 is defined in advance. In the embodiment, when the battery voltage is less than the near-end voltage V1, the image recording device 100 is not turned on.

Subsequently to step S306, the charging control unit 132 determines whether the battery voltage is greater than or equal to the charging restart voltage V2 (step S307). When the charging control unit 132 determines, at step S307, that the battery voltage is less than the charging restart voltage V2, the charging control unit 132 proceeds to step S304 and executes the process A. When the charging control unit 132 determines, at step S307, that the battery voltage is greater than or equal to the charging restart voltage V2, the processor 120 determines using the operation determination unit 134 whether the image recording device 100 is turned off (step S308).

When the processor 120 determines, at step S308, that the image recording device 100 is turned off, the process proceeds to step S304 and the charging control unit 132 executes the process A. When the processor 120 determines, at step S308, that the image recording device 100 is not turned off, the process of step S307 and the following steps are repeated.

Here, the charging restart voltage V2 is a threshold voltage for determining whether the charging of the battery 111 is to be restarted or not. The value of the charging restart voltage V2 is defined in advance. In the embodiment, the battery 111 is not charged until the battery voltage becomes less than the charging restart voltage V2. Further, in the embodiment, the charging restart voltage V2 is defined to be greater than or equal to a voltage that is required for the normal operation of the image recording device 100.

Hereinafter the process A is explained. The charging control unit 132 executes the process A. When the charging control unit 132 of the embodiment starts the process A, the charging control unit 132 causes the charging circuit 113 to start charging the battery 111 (step S311). Subsequently, the charging control unit 132 determines whether the battery 111 is fully charged, based on a detection result of the capacity detection circuit 114 (step S312). When the charging control unit 132 determines that the battery 111 is fully charged, the charging control unit 132 terminates charging of the battery 111 (step S313).

As described above, in the embodiment, the battery 111 is charged until the battery 111 is fully charged. Further, in the embodiment, the charging of the battery 111 is not restarted until the battery voltage of the battery 111 becomes less than the charging restart voltage V2. Therefore, in the embodiment, the battery 111 is prevented from repeating charging and discharging in a short time interval, and the number of charging cycles can be reduced. Hence, in the embodiment, deterioration of the battery 111, such as lowering of the battery voltage at the time that the battery 111 is fully charged or deformation of the shape of the battery 111 caused by swelling of the battery 111, can be suppressed. Further, in the embodiment, since the charging restart voltage V2 is defined to be greater than or equal to the voltage required for a normal operation of the image recording device 100, the operation of the image recording device 100 can be stabilized.

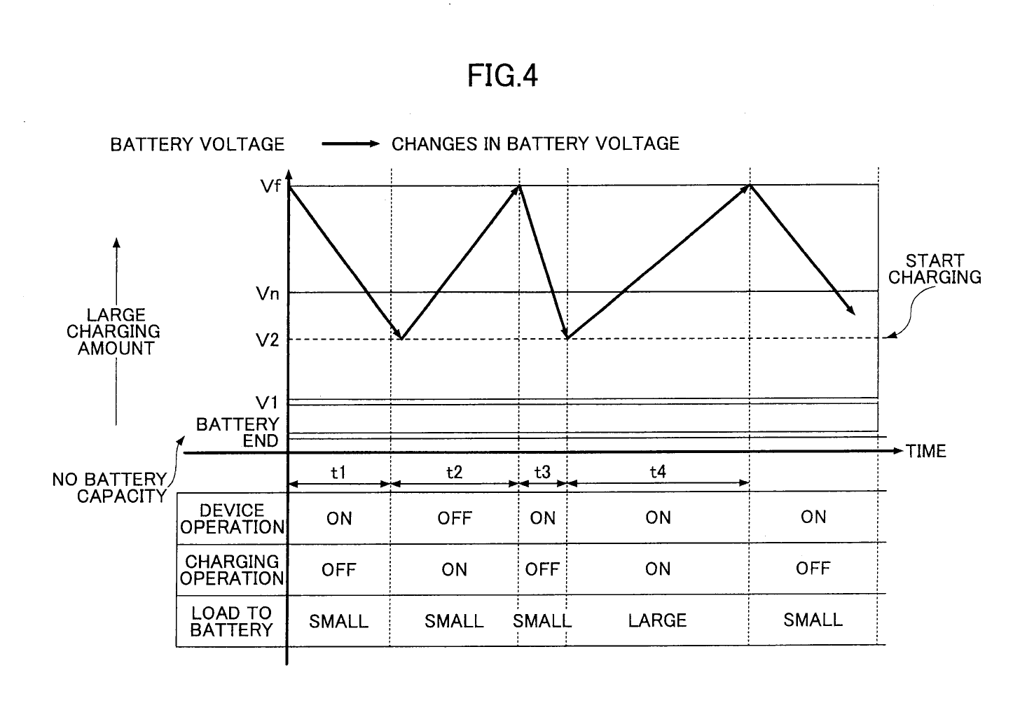

Hereinafter, the charging and discharging operation of the battery 111 in the image recording device 100 of the embodiment is further explained by referring to FIG. 4. FIG. 4 is a diagram illustrating the charging and discharging operations of the battery 111 in the image recording device 100. FIG. 4 indicates changes in the battery voltage of the battery 111, when the image recording device 100 is operated while the AC adapter 117 or the USB BUS 118 is connected to the USB connector 115. Here, the AC adapter 117 and the USB BUS 118 can be used as power supplies.

The graph corresponding to the time interval t1 in FIG. 4 indicates a change of the battery voltage after the battery 111 is fully charged and the image recording device 100 is turned on. Since, in the time interval t1, the battery voltage of the battery 111 is greater than or equal to the charging restart voltage V2, the battery 111 is not charged. In the time interval t2, the battery voltage of the battery 111 becomes less than the charging restart voltage V2. During the time interval t2, the image recording device 100 is turned off. In the time interval t2, after the battery voltage becomes less than the charging restart voltage V2, the charging of the battery 111 is started. During the charging of the battery 111, the image recording device 100 is kept turned off. In the time interval t2, the battery 111 is kept charging until the battery 111 is fully charged, namely, until the battery voltage of the battery 111 becomes a fully charged voltage Vf. Subsequently, in the time interval t3, the image recording device 100 is turned on, and the electric power stored in the battery 111 is consumed.

In the time interval t3, the electric power stored in the battery 111 is consumed until the battery voltage of the battery 111 becomes less than the charging restart voltage V2 while the image recording device 100 is turned on. In the time interval t4, the battery 111 is charged until the battery 111 is fully charged. In the time interval t4, during the charging of the battery 111, the image recording device 100 is turned on.

In the embodiment, the charging restart voltage V2 is set to be lower than the intermediate voltage Vh between the near-end voltage V1 and the fully charged voltage Vf. Further, in the embodiment, for example, the charging restart voltage V2 may be set to be equal to the near-end voltage V1.

In the above embodiment, the AC adapter 117 or the USB BUS 118 is connected to the USB connector 115 as the power supply of the charging current supplied to the battery through the charging circuit 113. However, the embodiment is not limited to this. For example, an AC adapter 117 that is connected to the image recording device 100 of the embodiment without being connected to the USB connector 115 may be used as the power supply of the charging current.

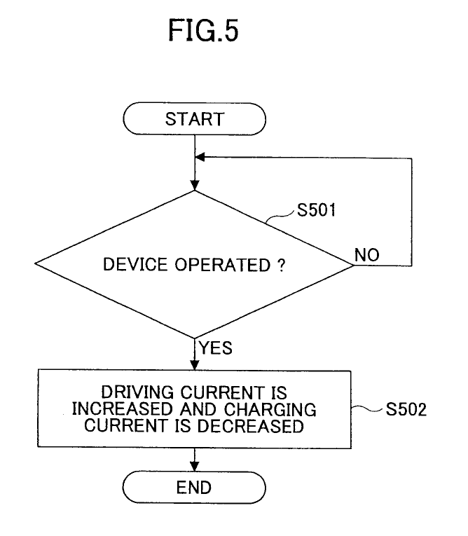

Further, in the image recording device 100 of the embodiment, it is possible that a current supplied from a power supply connected to the USB connector 115 is divided into a driving current of the image recording device 100 and a charging current of the battery 111. In such a case, when the image recording device 100 is operated (step S501) by an operator, in the image recording device 100, the driving current is increased and the charging current is decreased (step S502; cf. FIG. 5).

As described above, in the embodiment, when the image recording device 100 is operated, the driving current of the image recording device 100 is preferentially supplied. Thus the image recording device 100 is stably operated.

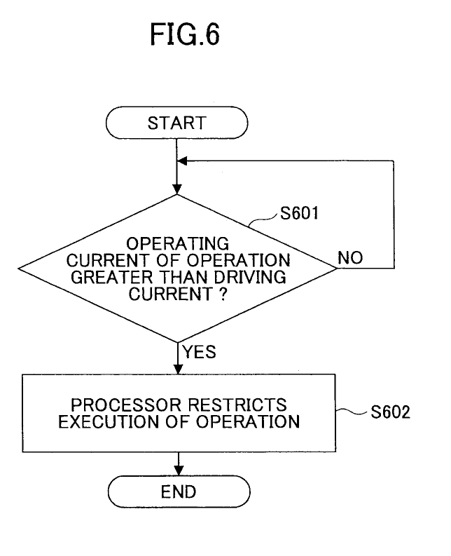

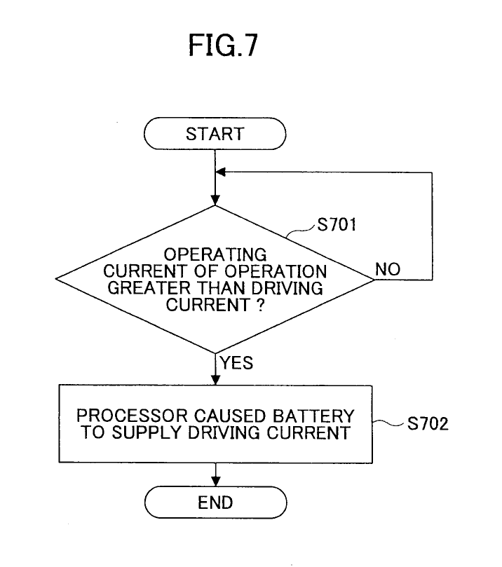

Further, in the image recording device 100 of the embodiment, when the processor 120 determines that an operating current of an operation is greater than the driving current supplied from the power supply (step S601), the processor 120 may restrict execution of the operation (step S602; cf. FIG. 6). In the recording device 100, by restricting the operation such that the operating current is greater than the driving current, the battery 111 under charging can be prevented from instantaneously discharging. Further, in the recording device 100, the processor 120 may not restrict an operation based on an amount of an operating current. In such a case, when the processor 120 determines that an operating current of an operation is greater than the driving current supplied from the power supply (step S701), the processor 120 may cause a current from the battery 111 to be supplied to the image recording device 100 (step S702; cf., FIG. 7).

Further, the embodiment is explained while assuming that the portable device is the image recording device 100. However, the embodiment is not limited to this. The embodiment may be applied to an arbitrary device which is driven by a rechargeable battery.

The present invention is not limited to the specifically disclosed embodiments, and variations and modifications may be made without departing from the scope of the present invention.

The present application is based on Japanese Priority Application No. 2011-032550, filed on Feb. 17, 2011, the entire contents of which are hereby incorporated herein by reference.

What is claimed is:

1. A portable device operated by a rechargeable battery, the portable device comprising:
a connecting unit configured to connect the portable device and a power supply that supplies a driving current for driving the portable device and a charging current for charging the rechargeable battery;
a detection unit configured to detect a battery voltage of the rechargeable battery; and
a charging control unit configured to control starting and stopping of charging of the rechargeable battery,
wherein, when the battery voltage is greater than or equal to a predetermined threshold value, the charging control unit causes the power supply to stop supplying the charging current to the rechargeable battery until the battery voltage becomes less than the predetermined threshold value, and
wherein, when the battery voltage is less than the predetermined threshold value, the charging control unit causes the power supply to start supplying the charging current to the rechargeable battery until the rechargeable battery is fully charged.

2. The portable device according to claim 1, further comprising:
an operation determination unit configured to determine whether the portable device is operated during charging of the rechargeable battery,
wherein, when the operation determination unit determines that the portable device is operated during charging, the charging control unit causes the charging current to be reduced and the driving current to be increased.

3. The portable device according to claim 1, further comprising:
a control unit configured to control an operation of the portable device,
wherein the control unit restricts execution of an operation when an operating current of the operation is greater than the driving current.

4. The portable device according to claim 1, further comprising:
a control unit configured to control an operation of the portable device,
wherein, when an operation is executed such that an operating current of the operation is greater than the driving current, the control unit causes the rechargeable battery to supply the driving current.

5. The portable device according to claim 1,
wherein the predetermined threshold value is less than an intermediate voltage value between a lower limit value of the battery voltage for operating the portable device and a value of the battery voltage when the rechargeable battery is fully charged, and
wherein the predetermined threshold value is set to a value greater than the lower limit value of the battery voltage.

6. The portable device according to claim 1,
wherein the predetermined threshold value is set to a lower limit value of the battery voltage for operating the portable device.

7. The portable device according to claim 1,
wherein the connecting unit has a function to communicate with an external device connected to the portable device.

8. The portable device according to claim 1,
wherein the connecting unit conforms to a USB standard.

9. An image recording device operated by a rechargeable battery, the image recording device comprising:
a connecting unit configured to connect the image recording device and a power supply that supplies a driving current for driving the image recording device and a charging current for charging the rechargeable battery;
a detection unit configured to detect a battery voltage of the rechargeable battery; and
a charging control unit configured to control starting and stopping of charging of the rechargeable battery,
wherein, when the battery voltage is greater than or equal to a predetermined threshold value, the charging control unit causes the power supply to stop supplying the charging current to the rechargeable battery until the battery voltage becomes less than the predetermined threshold value, and
wherein, when the battery voltage is less than the predetermined threshold value, the charging control unit causes the power supply to start supplying the charging current to the rechargeable battery until the rechargeable battery is fully charged.
